(19) United States
(12) Patent Application Publication
(10) Pub. No.: US 2016/0059395 A1
(43) Pub. Date: Mar. 3, 2016

(54) TORQUE WRENCH

(71) Applicant: HL Technology SA, La Chaux-de-Fonds (CH)

(72) Inventor: François HUGUELET, Chezard-Saint-Martin (CH)

(21) Appl. No.: 14/763,655

(22) PCT Filed: Jan. 28, 2014
(86) PCT No.: PCT/CH2014/000009

§ 371 Date: Nov. 3, 2015

(30) Foreign Application Priority Data
Jan. 29, 2013 (CH) 00367/13

(51) Int. Cl. B25B 23/142; B25B 13/46; A61C 8/00; B25B 23/14

(52) U.S. Cl. CPC B25B 23/1427; B25B 23/141; B25B 13/46; A61C 8/0089

(57) ABSTRACT

As torque wrench (10) including a handle grip (11) and at least one head (12) that holds a clamping tool (13, 14) in the form of a rotary socket (16) located at one extremity of a handle grip (11) on of the torque wrench (10). The rotary socket (16) is housed in an annular element (17) integral with the head and comprises a central opening (18) defined by a hexagonal wall with facets (19). The torque wrench (10) further includes a spring element corresponding to the head (12) which comprises a at least one blade spring (22). In the constrained position, the free end of the blade spring (22) is blocked against a side (29) of a tooth (21) and blocks the rotary socket (16). This socket can be released after the blade spring (22) buckles and slides along the side of the tooth (21).

This application is a National Stage completion of PCT/CH2014/000009 filed Jan. 28, 2014, which claims priority from Swiss patent application serial no. 00367/12 filed Jan. 29, 2013.

### FIELD OF THE INVENTION

The present invention concerns a torque wrench, clamping and/or unclamping an object, particularly a dental implant or the like, the wrench comprising a handle grip and at least one clamping tool integral with one extremity of the handle grip, the tightening tool comprising a rotary socket and comprising an interior opening defined by a faceted wall adapted to the shape and dimensions of the object to be clamped or unclamped.

### BACKGROUND OF THE INVENTION

Torque wrenches of this type are already known, and manufactured according to the concept of ratcheted wrenches comprising a turning clamping tool with a central opening defined by a faceted wall and comprising an exterior wall equipped with peripheral notches. In addition, these wrenches generally comprise balls or pins, each urged by a spiral spring into a position of engagement with the peripheral notches in order to ensure that the rotary tightening tool is blocked in an anti-return position with maximum tightening torque.

Often a large number of mechanical elements are necessary to ensure the torque wrench limits tightening torque, posing a problem of overcrowding due to space limitations, for example, during an orthodontic procedure.

Furthermore, adjusting the tension of the spiral springs is a delicate procedure and unreliable over time. In practice, the tension of a small size spiral spring does not remain constant over time and may vary depending on conditions of use, particularly temperature.

Other types of torque wrenches have been developed to simplify these known systems and are illustrated specifically in U.S. Pat. No. 5,224,403 and European Patent Application EP 1 731 114 A1. The first one describes a torque wrench designed for dental use comprising a gear equipped with peripheral teeth in which a single ball respectively engages, urged by an axially movable rod when pushed by the user via an adjustment mechanism acting on an axial spring. The adjustment mechanism exerts a force of variable strength on the spring, one end of which contacts the ball.

The second one has the same general configuration but instead of the ball mechanism, it comprises a spring and push rod, a blade spring, one end of which enters directly inside the cavities separating the teeth of the gear to exert retention torque on the gear. This mechanism is not precise and it is subject to rapid wear.

In addition, presently used torque wrenches are not able to simultaneously fulfill the principal function, which is to limit torque for clamping and unclamping an object, but also its secondary functions of ratchet handle and unscrewing tool.

For this reason, torque wrenches presently in use have both structural and functional disadvantages. For some, their complexity results in a long, delicate assembly process and extremely high manufacturing costs; for others, their design does not lend itself to medical or dental purposes because of the hygiene and safety constraints inherent in these fields.

### SUMMARY OF THE INVENTION

The present invention proposes to improve upon the disadvantages listed above with a torque wrench specifically for positioning objects such as dental implants, for example, a torque wrench that is simple in concept, uncomplicated and economical to manufacture, easy to adjust, and remains reliably adjusted over time whatever the conditions of use.

This goal is achieved by the torque wrench of the invention as defined in the preamble and characterized in that the rotary socket on the clamping tool comprises a toothed peripheral wall concentric to the faceted wall, in that the handle grip holds at least one blade spring with a first fixed extremity mounted in the handle grip, and a second free extremity in contact with the toothed peripheral wall, the blade spring moving between a first position, call the constrained position in which the second extremity is blocked against one side of one of the teeth on the peripheral wall of the clamping tool, the constrained position being maintained so long as the force applied by the user on the handle grip is below a predetermined threshold, and a second position, called the release position, in which the second extremity has detached from the side of the tooth and slides along the wall of the tooth after the at least one blade spring buckles when the user applies force on the handle, the force being at least equal to the predetermined threshold.

According to an advantageous embodiment, the handle grip has two mutually parallel blade springs each with a first fixed extremity, mounted in the handle grip, and a second free extremity in contact with the toothed peripheral wall, the blade springs moving between a first position, called the constrained position, in which the second released extremity of each of the blade springs is blocked against one respective side of one of the teeth on the peripheral wall, the constrained position being maintained so long as the force applied on the handle by the user is below a predetermined threshold, and a second position called the released position in which their released respective second extremity has detached from the corresponding sides of the teeth in the peripheral wall after the blade spring buckles when the user applies force on the handle, the force being at least equal to the predetermined threshold.

Advantageously the handle grip may have a head at each opposing extremity, each of the heads comprising a clamping tool, one of the clamping tools being equipped with a single blade spring and the other clamping tool being equipped with two blade springs.

According to one of the variations, the at least one blade spring is mounted on one of the extremities on a fixed block in the handle of the torque wrench and comprising a free extremity, is housed within an opening formed in the handle allowing the blade spring to buckle when pressure is applied on the handle grip.

According to another variation the blade spring is generally tangential relative to the peripheral wall of the clamping socket.

Preferably, each of the blade springs comprises one extremity mounted on a fixed block in the handle of the torque wrench, the fixed blocks being laterally offset from one another and the blade springs being housed in the opening formed in the handle to allow the blade springs to buckle when pressure is applied on the handle grip.

Advantageously, the clamping tool may be made like a rotary socket generally shaped like a cylindrical ring open on both sides allowing the clamping tool to engage with the object on either side, such that the torque wrench functions like a ratchet handle.

In an especially advantageous manner, the teeth are asymmetrical, with one side of each of the teeth being essentially parallel to the blade spring in the constrained position and the other side of each of the teeth being generally perpendicular to the blade spring in constrained position.

The side of the tooth perpendicular to the blade spring in the constrained position preferably is equal in thickness to the thickness of the blade spring that is blocked against it.

In case of a torque wrench comprising two blade springs, both blade springs (23,24) may be parallel to one another or they may form an acute angle with one another.

### BRIEF DESCRIPTION OF THE DRAWINGS

The present invention and its principal advantages will be better understood from the description of different embodiments with reference to the attached drawings, in which:

FIG. 1 represents a plane view of an advantageous embodiment of the torque wrench according to the invention, the wrench being shown in what is called the “constrained” position.

FIG. 2 is a plane view of the embodiment of FIG. 1 of the torque wrench according to the invention, the wrench being shown in what is called the “released” position.

FIG. 3 is an enlarged view of the head of the torque wrench with a blade spring shown in the position known as constrained.

FIG. 4 is an enlarged view of the head of the torque wrench with a blade spring shown in the position known as released.

FIG. 5 is an enlarged view of the head of the torque wrench with two blade springs shown in the position known as constrained.

FIG. 6 is an enlarged view of the head of the torque wrench with two blade springs shown in the position known a free.

### DETAILED DESCRIPTION OF THE PREFERRED EMBODIMENTS

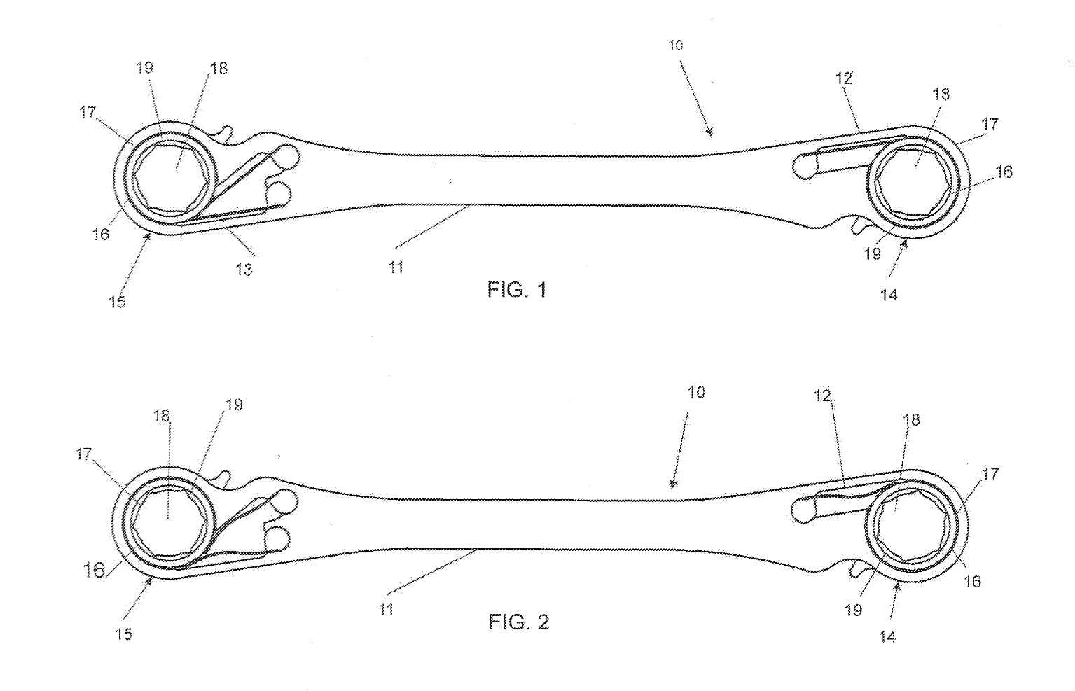

With reference to FIG. 1, the torque wrench 10 represented comprises a handle grip 11 and two heads, 12 and 13, respectively, each holding a clamping tool 14 and 15 located at the two opposing extremities of torque wrench 10. According to an embodiment not shown, torque wrench 10 may comprise only a single head with a single clamping tool. Each of the clamping tools 14 and 15 are in the form of a rotary socket 16 housed in an annular piece 17 integral with corresponding head 12, 13. Rotary socket 16 comprises a central opening 18 defined by a faceted wall 19, the wall being hexagonal, for example, or having a surface adapted to the shape of the object to be tightened, such as a dental implant or the like. The socket is shaped like a relatively flat tubular cylindrical ring with the same opening on both surfaces. Because of this, the socket is reversible and may engage an object with both surfaces. The primary purpose of this faceted wall is to allow damping when positioning an object, the clamping being accomplished in a controlled manner by virtue of the torque limiting function of the torque wrench 10. Rotary socket 16 also comprises a peripheral wall 20 equipped with teeth 21 that cooperate with a spring element to limit the clamping torque of the object to be clamped.

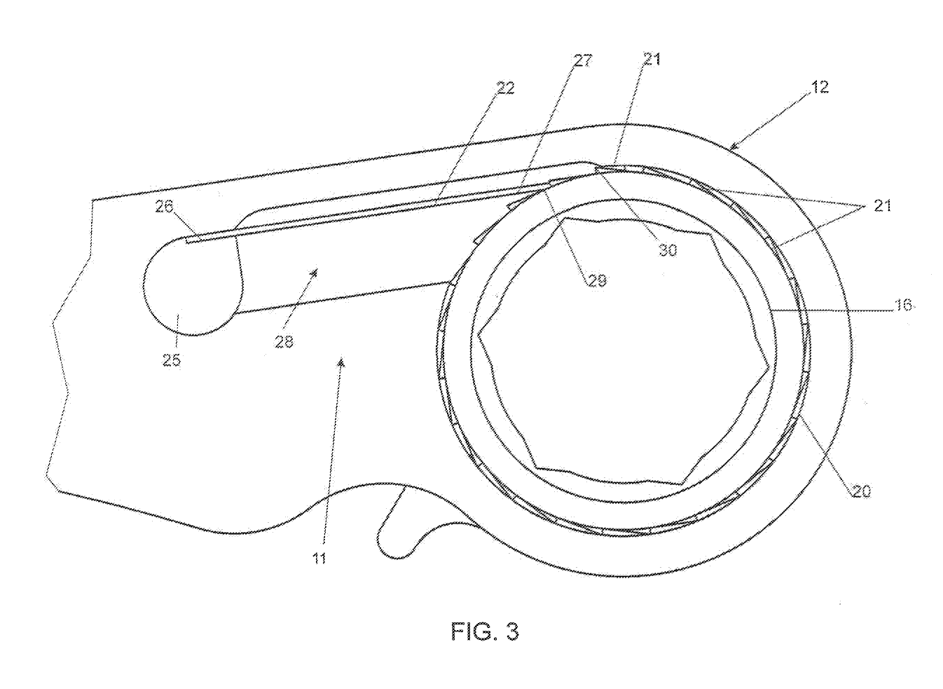

In the example shown, the spring element corresponding to head 12 consists of a single blade spring 22 and the spring element corresponding to head 13 consists of two blade springs 23 and 24. FIG. 1 represents the torque wrench in its constrained position. The enlarged detailed views illustrate operation of the wrench and the interaction between the different operating components, particularly teeth 21 and blade springs 22, 23 and 24. Blade spring 22 is attached to a fixed block 25 at one of its extremities 26 and contacts one side of a tooth 21 at its other free end 27. This constrained position is shown in FIG. 1 and FIG. 3. The blade spring is located in a recess 28 formed in handle 11 allowing the blade to buckle after pressure is applied to the handle when clamping the object.

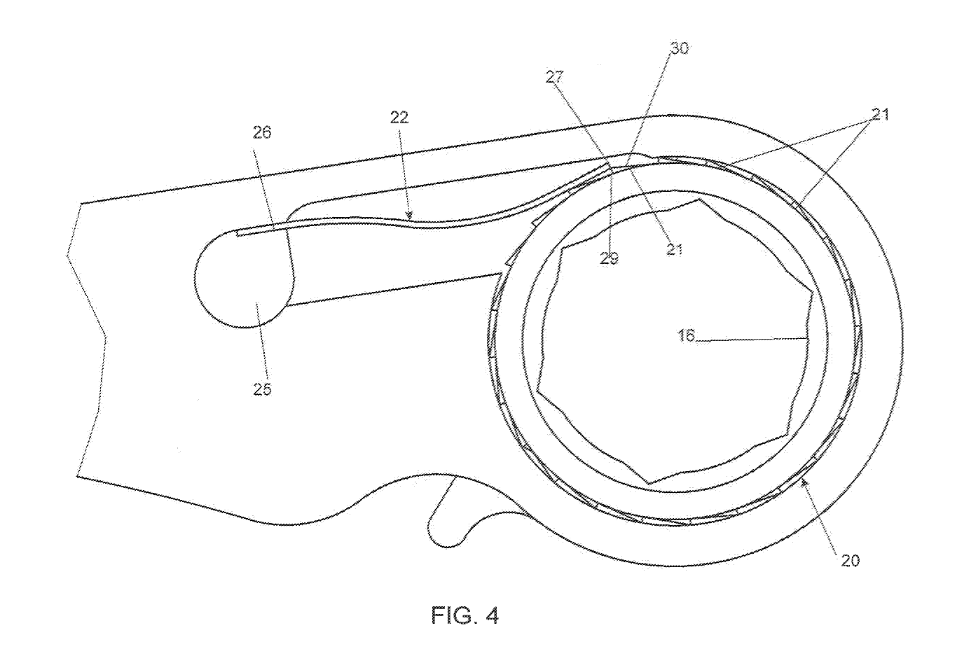

During operation, when the user wishes to position and clamp an object using the clamping tool 14 on head 12, so long as the force exerted on handle 11 which is transmitted to rotary socket 16 is below a given value called the threshold, the blade spring 22 will remain generally rectilinear. Free end 27 contacts one side 29 of one tooth 21. Each tooth 21 comprises a side 29 that is generally perpendicular to the blade spring when the latter is in the constrained position and one side 30 that is generally parallel to the blade spring when the latter is in the constrained position. Its free extremity 27 remains in contact with side 29 of a tooth 21 and the rotary socket is blocked in position. When the force applied to handle 11 by the user exceeds the threshold, the blade spring begins to buckle and to curve into a defined position in which free end 27 detaches from side 29 of the tooth 21 against which blade spring 22 was blocked following contact with the next tooth 21 in the direction in which the socket is rotating. This position corresponds to the clamping torque limit on rotary bushing 16 and to maximum force capable of being applied by the user on handle 11 of the torque wrench. This position, called the release position, is illustrated by FIG. 2 and FIG. 4.

In addition to its principal function of a torque limiter, torque wrench 10 also plays a first complementary role, which is that of ratchet wrench. This function is fulfilled when the user turns the wrench in the opposite direction of the clamping direction, returning to the initial position. During this displacement the one or more blade springs offer only slight resistance to rotation of rotary socket 16 and they bend as teeth 21 pass one after the other.

A second complementary role is as an unscrewing wrench. It is only necessary to turn the wrench back 180° on its longitudinal axis. Free end 27 of the blade spring (or blade springs in the variation with two blade springs) blocks side 29 of the one or two teeth 21, thereby unscrewing the object.

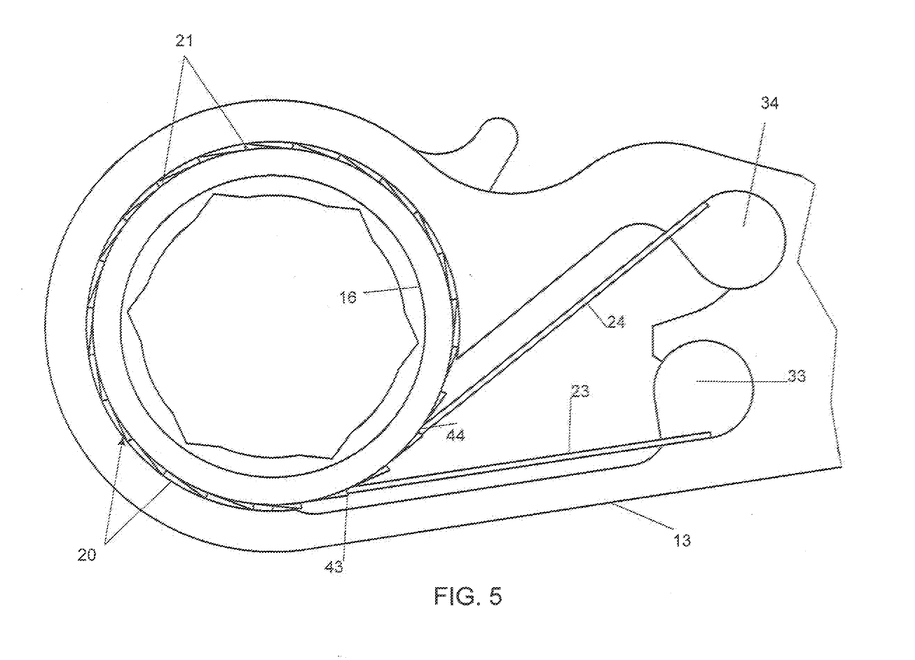

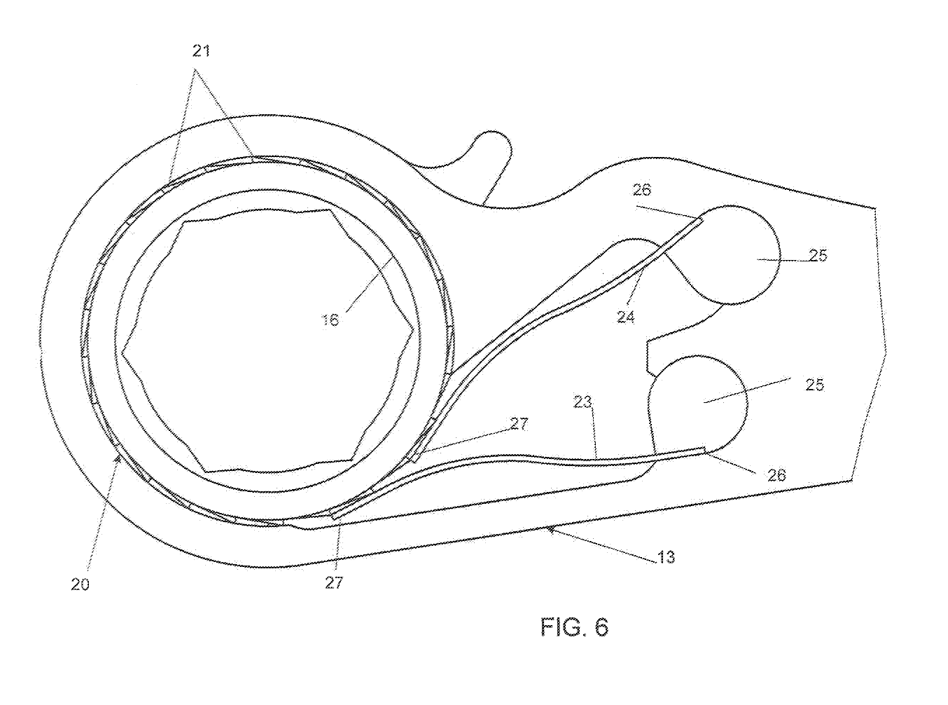

FIGS. 1 through 5 show head 13 and clamping tool 15 with two blade springs 23 and 24 in the constrained position and FIGS. 2 and 6 show head 13 and clamping tool 15 with two blade springs 23 and 24 in the released position. Blade springs 23 and 24 are respectively attached to a fixed block 33 and 34 by one extremity 36 and respectively contact the side of a tooth 21 at their other free extremity 43 and 44. This constrained position is shown in FIG. 1 and FIG. 3.

During operation, when the user wishes to position an object and clamp it in place using the clamping tool 15 of head 13, that is, to use the wrench for its principal function, so long as the force exerted on handle 11, which is transmitted to rotary socket 16, is below a given value, blade springs 23 and 24 remain generally rectilinear. Their free ends 43 and 44 remain in contact with the respective sides of the two teeth 21 and rotary socket 16 is blocked in position. When the force applied to handle 11 by the user exceeds the given value, the blade springs begin to flex to attain a position limit in which free ends 43 and 44 detach respectively from the side of teeth 21 against which blade springs 23 and 24 had been blocked. This position corresponds to the locking torque threshold of rotary socket 16 and to the maximum force that can be applied by the user to handle 11 of torque wrench 10. This position, called the released position, is illustrated in FIG. 2 and FIG. 6.

The present invention is not limited to the forms of embodiment described, but may undergo different modifications or variations. Embodiments of torque wrenches that operate according to the same principle, but comprise only a single head equipped with one or two blade springs are conceivable. The choice of blade springs s well as the shape of the teeth on the peripheral wall of the rotary socket define the clamping torque threshold of the torque wrench

1-8. (canceled)

9. A torque wrench (10) for at least one of clamping and unclamping an object, particularly a dental implant or the like, the wrench comprising:
a handle grip (11);
at least one clamping tool (13,14) that is integral with one extremity of the handle grip (11), the damping tool comprising a rotary socket (16) and an interior opening (18) that is defined by a faceted wall (19) adapted to a shape and size of the object to be at least one of damped and unclamped,
the rotary socket (16) on the damping tool (13, 14) comprising a peripheral wall (20) having teeth (21) concentric with the faceted wall (19);
the handle grip (11) supporting at least one blade spring (22, 23, 24) having a first fixed extremity (26) that is mounted in the handle grip (11) and a second free extremity (27) that contacts the teeth (21) of the peripheral wall (20);
the blade spring (22, 23, 24) moving between a constrained position, in which the second free extremity is blocked against a side of one of the teeth (21) on the peripheral wall (20) of the clamping tool (13, 14), and the constrained position being maintained so long as a force applied by a user on the handle grip (11) is below a predetermined threshold, and
a released position in which the second free extremity (27) becoming separated from the side of the tooth (21) and sliding along the side of the tooth (21), following buckling of the at least one blade spring (22, 23, 24) from the force applied on the handle by the user, with the force being at least equal to the predetermined threshold.

10. The torque wrench according to claim 9, wherein the handle grip (11) holds two blade springs (23, 24), each of the two blade springs has the first fixed extremity (26) mounted in the handle grip and the second free extremity (27) in contact with the teeth (21) of the peripheral wall (20), the two blade springs (23, 24) moving between the constrained position, in which the second free extremity of each of the two blade springs is blocked against one respective side of one of the teeth (21) of the peripheral wall, the constrained position is maintained so long as the force applied by the user on the handle is below the predetermined threshold; and the released position, in which the second free extremity becomes detached from the corresponding sides of the teeth on the peripheral wall, following buckling by the two blade springs when the force is applied by the user on the handle, the force being at least equal to the predetermined threshold.

11. The torque wrench according to claim 9, wherein the handle grip (11) holds a head (12, 13) on each of the opposite extremities of the handle grip, each of the heads comprises a clamping tool (14, 15), one of the clamping tools is equipped with a single blade spring (22) and the other clamping tool is equipped with two blade springs (23, 24).

12. The torque wrench according to claim 9, wherein the first fixed extremity of the at least one blade spring (22, 23, 24) is mounted on a fixed block (25) in the handle grip of the torque wrench and the second free extremity of the at least one blade spring is housed in an opening formed in the handle grip (11) that allows the at least one blade spring to buckle when force is applied to the handle grip.

13. The torque wrench according to claim 9, wherein the at least one blade spring (22, 23, 24) is arranged substantially tangential relative to the peripheral wall (20).

14. The torque wrench according to claim 12, wherein the torque wrench comprises two blade springs, each one of the two blade springs (23, 24) comprises a first fixed extremity that is mounted on a fixed block (16) in the handle grip (11) of the torque wrench, the fixed blocks are laterally offset from one another and the two blade springs are housed in the opening formed in the handle grip allowing the two blade springs to buckle when the force is applied to the handle grip.

15. The torque wrench according to claim 9, wherein the rotary socket (16) is generally shaped like a cylindrical ring that is open on both sides so that the clamping tool is engagable with the object on either side such that the torque wrench functions as a ratchet wrench.

16. The torque wrench according to claim 9, wherein the teeth (21) comprise an asymmetrical profile, one of the sides of each of the teeth being generally parallel to the blade spring (23, 24) in the constrained position, and another side of each of the teeth being generally perpendicular to the blade spring in the constrained position.

17. The torque wrench according to claim 8, wherein the side of the tooth (21) perpendicular to the blade spring (23, 24) in the constrained position is substantially equal in thickness to a thickness of the blade spring that is blocked against the tooth (21).

18. The torque wrench according to claim 14, comprises two blade springs and each of the two blade springs (23, 24) extend parallel to one another.

19. The torque wrench according to claim 14, comprises two blade springs and each of the two blade springs (23, 24) form an acute angle with one another.
